(19) United States
(12) Patent Application Publication
(10) Pub. No.: US 2026/0203176 A1
(43) Pub. Date: Jul. 16, 2026

(54) MANAGEMENT SYSTEM

(71) Applicant: Hitachi Vantara, Ltd., Yokohama-shi (JP)

(72) Inventors: Kaori NAKANO, Tokyo (JP); Shinichi HAYASHI, Tokyo (JP)

(73) Assignee: Hitachi Vantara, Ltd., Yokohama-shi (JP)

(21) Appl. No.: 19/312,418

(22) Filed: Aug. 28, 2025

(30) Foreign Application Priority Data
Jan. 14, 2025 (JP) 2025-004711

(51) Int. Cl. G06F 11/20

(52) U.S. Cl. CPC G06F 11/2094; G06F 2201/80

(57) ABSTRACT

A management target system includes a storage cluster including a plurality of storage nodes and a database cluster including a plurality of database nodes. The plurality of storage nodes include a plurality of active storage nodes arranged in a first zone and a plurality of standby storage nodes arranged in a second zone. The plurality of database nodes include a plurality of active database nodes arranged in the first zone and a plurality of standby database nodes arranged in the second zone. A management system detects anomaly in the first zone, determines which of a zone failure, a failure of only the storage node, and a failure of only the database node corresponds to a cause of the anomaly, and creates an instruction for operating the management target system according to a result of the determination.

### CLAIM OF PRIORITY

The present application claims priority from Japanese patent application JP 2025-004711 filed on January 14, 2025, the content of which is hereby incorporated by reference into this application.

### BACKGROUND OF THE INVENTION

### 1. Field of the Invention

The present invention relates to management of a target system.

### 2. Description of the Related Art

JP-2022-145964-A is one of related arts of the present application. For example, JP-2022-145964-A discloses the following configuration (see ABSTRACT OF THE DISCLOSURE).

Each of redundant groups includes one active program (storage control program of active program) and N (N: two or larger integer) standby programs. A priority for designation as a failover (FO) destination is set for each of the N standby programs. In this case, FO from the active programs to the standby programs is implemented according to the priorities set in the same redundant group. For a plurality of storage control programs each including an active program and standby programs switched to active programs by FO in a plurality of redundant groups arranged at the same node, standby storage control programs each selectable as an FO destination for each of the storage control programs are arranged at different nodes.

For example, a redundant configuration is constructed between two sub-systems provided in different locations (zones), such as different availability zones, and a redundant configuration is constructed in each of the availability zones for improving system availability. The availability system thus configured requires appropriate handling for failures caused in the system.

### SUMMARY OF THE INVENTION

One aspect of the present invention is directed to a management system for managing a management target system. The management system includes one or more processors and one or more storage devices. The management target system includes a storage cluster that includes a plurality of storage nodes and a database cluster that includes a plurality of database nodes. The plurality of storage nodes include a plurality of active storage nodes arranged in a first zone and a plurality of standby storage nodes arranged in a second zone. The plurality of database nodes include a plurality of active database nodes arranged in the first zone and a plurality of standby database nodes arranged in the second zone. Failover is executed between the plurality of active storage nodes and the plurality of standby storage nodes. Failover is executed between the plurality of active database nodes. The one or more storage devices store management information. The management information includes information associated with an active type or a standby type and a zone of each of the plurality of storage nodes and status information associated with the storage nodes, and information associated with an active type or a standby type, a zone, and an access destination storage node of each of the plurality of database nodes and status information associated with the database nodes. With reference to the management information, the one or more processors detect anomaly in the first zone, determine which of a zone failure, a failure of only the storage node, and a failure of only the database node corresponds to a cause of the anomaly, and create an instruction for operating the management target system according to a result of the determination.

According to the one aspect of the present invention, appropriate handling for failures is achievable.

### BRIEF DESCRIPTION OF THE DRAWINGS

FIG. 1A illustrates a logical configuration of a computer system according to one example;

FIG. 1B illustrates a logical configuration example of a database (DB) management system;

FIG. 1C illustrates a logical configuration example of a management target system;

FIG. 2 illustrates a hardware configuration example of a computer system according to example 1;

FIG. 3 illustrates a configuration example of DB configuration information;

FIG. 4 illustrates a configuration example of storage configuration information;

FIG. 5 illustrates a configuration example of DB status information;

FIG. 6 illustrates a configuration example of storage status information;

FIG. 7 is a flowchart illustrating a process example of a failover determination program;

FIG. 8 is an example of a flowchart illustrating an availability zone (AZ) failure instruction creation process;

FIG. 9 is an example of a flowchart illustrating a storage node failure instruction creation process;

FIG. 10 is an example of a flowchart illustrating a DB failover instruction creation process;

FIG. 11 is an example of a flowchart illustrating a DB node failure instruction creation process;

FIG. 12 is an example of a flowchart illustrating a process example of a failover execution program;

FIG. 13 is a flowchart illustrating a failover instruction creation process according to example 2;

FIG. 14 illustrates a configuration example of DB nodes according to example 3;

FIG. 15 illustrates a configuration example of DB configuration information according to example 3;

FIG. 16 is a flowchart illustrating a DB failover instruction creation process according to example 3;

FIG. 17A illustrates an example of a layout of DB nodes and access destination volumes of the DB nodes according to example 4;

FIG. 17B illustrates an example of a layout of DB nodes and access destination volumes of the DB nodes;

FIG. 18 illustrates a configuration example of storage node capacity and performance information;

FIG. 19 illustrates an example of a DB deployment setting screen displayed by a DB deployment program; and

FIG. 20 is a flowchart illustrating an example of a DB node arrangement process.

### DESCRIPTION OF THE PREFERRED EMBODIMENTS

Examples of the present invention will hereinafter be described with reference to the drawings. In the accompanying drawings, elements having similar functions will be given similar reference numbers in some cases. The accompanying drawings illustrate specific embodiments and examples practiced based on the principle of the present invention. These embodiments and examples will be discussed only for easy understanding of the present invention. Accordingly, it is not intended that the respective embodiments and examples should impose any limitations on interpretation of the present invention. Moreover, to the same type of elements in the following description, only common signs included in reference signs will be given in cases where distinction between the elements is not required, and reference signs (or identifications (IDs) of elements (identification numbers, etc.)) are used in cases where distinction between the elements is required.

### Example 1

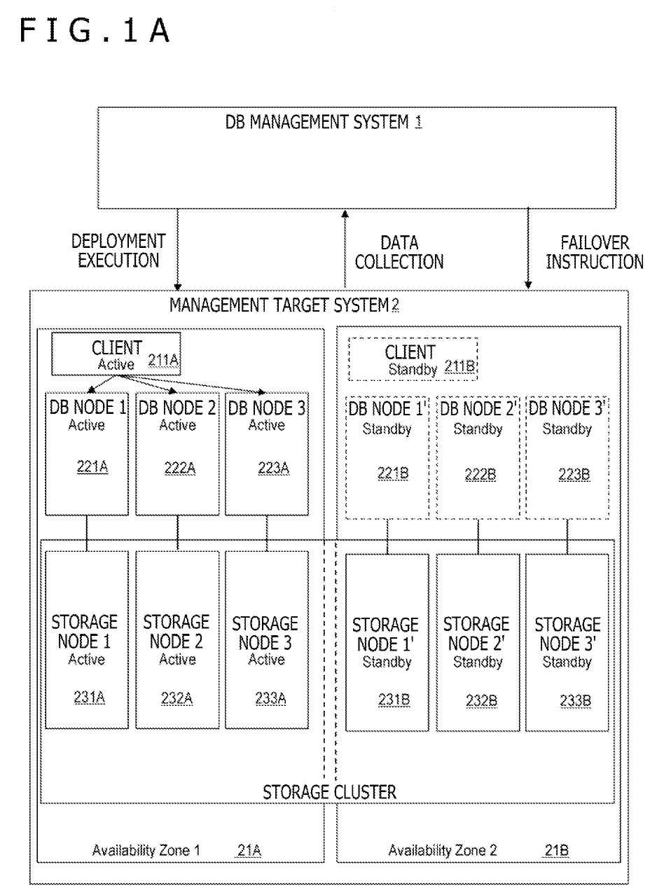

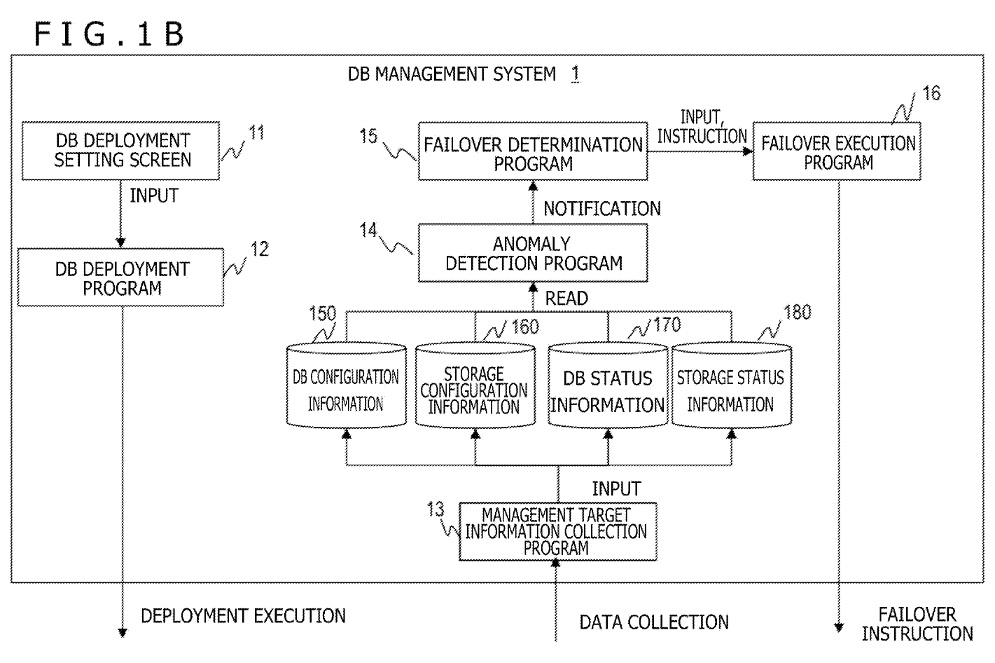

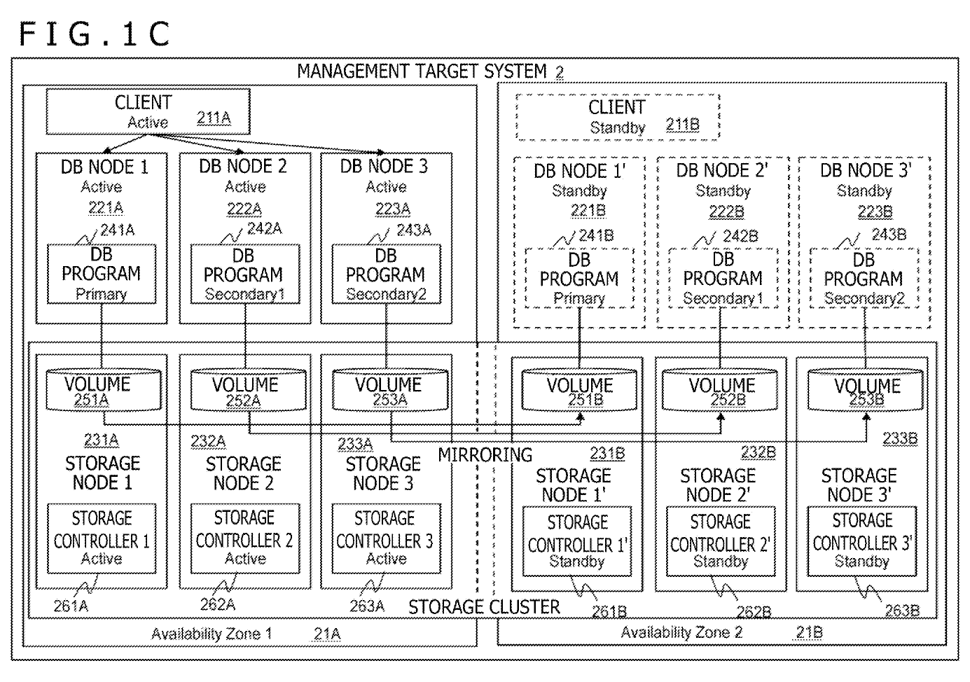

FIG. 1A illustrates a logical configuration of a computer system according to one example of the present specification. A DB management system 1 manages and controls a management target system 2. The management target system 2 includes two availability zones 21A and 21B. Each of the availability zones is a system or a management unit which includes one or more data centers and is independently operable and usable in a cloud service. The system including one or more availability zones is called a region. Each of the availability zones and the regions is a type of zones formed at different locations.

The availability zones 21A and 21B exist at different locations. Discussed hereinafter will be an example of a cloud service. However, for access between systems, there are also available two systems which are of a type different from availability zones and can produce a delay of access within each of the systems.

The availability zone 21A includes a client 211A, DB nodes 221A, 222A, and 223A, and storage nodes 231A, 232A, and 233A. The availability zone 21B includes a client 211B, DB nodes 221B, 222B, and 223B, and storage nodes 231B, 232B, and 233B.

The active (operating) client 211A uses the active DB nodes 221A, 222A, and 223A in the availability zone 21A. For example, the active client 211A is a web server. The active DB nodes 221A, 222A, and 223A constitute an active distributed DB system (cluster). Note that the number of DB nodes constituting the operating distributed DB system is two or any number larger than two.

The active DB node 221A accesses the storage node 231A, and writes and reads data to and from the storage node 231A. The active DB node 222A accesses the storage node 232A, and writes and reads data to and from the storage node 232A. The active DB node 223A accesses the storage node 233A, and writes and reads data to and from the storage node 233A. While each of the DB nodes accesses one storage node in the configuration example illustrated in FIG. 1A, the number of storage nodes to be accessed may be any number.

The standby (waiting) client 211B uses the standby DB nodes 221B, 222B, and 223B in the availability zone 21B. The standby DB nodes 221B, 222B, and 223B constitute a standby DB cluster (standby distributed DB system). Note that the number of DB nodes constituting the standby DB cluster may be equal to the number of DB nodes constituting the active DB cluster. The operating DB cluster and the waiting DB cluster may be combined and regarded as one DB cluster.

The standby DB node 221B accesses the storage node 231B, and writes and reads data to and from the storage node 231B. The standby DB node 222B accesses the storage node 232B, and writes and reads data to and from the storage node 232B. The standby DB node 223B accesses the storage node 233B, and writes and reads data to and from the storage node 233B. While each of the DB nodes accesses the one storage node in the configuration example illustrated in FIG. 1A, the number of storage nodes to be accessed may be any number.

The storage nodes 231A, 232A, 233A, 231B, 232B, and 233B arranged in the availability zones 21A and 21B operate in cooperation with each other, and constitute a storage cluster. The storage nodes 231A, 232A, and 233A are active storage nodes, while the storage nodes 231B, 232B, and 233B are standby storage nodes.

Each of the DB nodes 221A, 222A, 223A, 221B, 222B, and 223B may be a bare-metal server (hardware computer), or a node virtualized in hardware, such as a virtual machine, a container, and a “DB instance” which is a virtual server defined by database management software. For example, each of the storage nodes 231A, 232A, 233A, 231B, 232B, and 233B may be a bare-metal server (hardware computer), or a node virtualized in hardware, such as a virtual machine and a container.

The DB management system 1 collects data from the management target system 2 as needed to manage and control the management target system 2. The DB management system 1 executes deployment of the DB nodes to construct the distributed DB system or add the DB nodes to the distributed DB system. The DB management system 1 gives an instruction for carrying out necessary failover when a failure is caused in the management target system 2.

FIG. 1B illustrates a logical configuration example of the DB management system 1. The DB management system 1 includes a DB deployment setting screen 11 and a DB deployment program 12. The DB deployment program 12 executes deployment of the DB nodes in accordance with setting information input from a manager via a graphical user interface (GUI) of the DB deployment setting screen 11.

The DB management system 1 includes a management target information collection program 13, an anomaly detection program 14, a failover determination program 15, and a failover execution program 16. The management target information collection program 13 collects information from the management target system 2, and stores the collected information in a plurality of databases. The information to be collected and managed includes DB configuration information 150, storage configuration information 160, DB status information 170, and storage status information 180.

The anomaly detection program 14 detects anomaly in the management target system 2 with reference to the pieces of stored information 150, 160, 170, and 180. The failover determination program 15 executes a determination process and an instruction creation process associated with failover carried out in the management target system 2 in response to notification from the anomaly detection program 14. The failover execution program 16 issues instructions designated by the failover determination program 15 to the management target system 2 in a designated order.

FIG. 1C illustrates a logical configuration example of the management target system 2. The active DB nodes 221A, 222A, and 223A execute the DB programs 241A, 242A, and 243A, respectively, in the availability zone 21A.

The DB program 241A is a primary DB program, and the DB programs 242A and 243A are secondary DB programs. While each of the DB nodes 221A, 222A, and 223A executes the corresponding one DB program according to the present example, the number of DB programs to be executed is not limited to one and may be more than one. According to the present example, the DB node 221A is also referred to as a primary DB node, while each of the DB nodes 222A and 223A is also referred to as a secondary DB node. For the operating DB program (DB node), the number of primary DB programs is one, and the number of secondary DB programs is any number that is one or more.

The primary DB program 241A (primary DB node 221A) receives a read request and a write request from the client 211A, and processes the received requests. Each of the secondary DB programs 242A and 243A (secondary DB nodes 222A and 223A) receives only a read request from the client 211A, and processes the received request.

The primary DB program 241A stores update data received from the client 211A in the storage node 231A, and transmits copy data of this update data to the secondary DB programs 242A and 243A. The secondary DB programs 242A and 243A store the received copy data in the storage nodes 232A and 233A, respectively.

As apparent from above, the update data received from the client 211A is made redundant by copying requiring communication between the DB nodes. Meanwhile, the DB programs 241A, 242A, and 243A communicate with each other, and execute failover in a case of anomaly in any of the DB nodes. An external server which manages the distributed DB system may determine execution of failover. It is assumed in the following description that failover is independently executed at the time of a failure caused in the DB cluster (DB nodes 221A, 222A, and 223A). Failover carried out in the distributed DB system is a known technology, and therefore will not be discussed here.

Each of the standby client 211B and the standby DB nodes 221B, 222B, and 223B stops in a cold standby status in the availability zone 21B. In this state, delays of access from the client 211A and the number of operating DB nodes can be reduced. However, the DB nodes may operate in the availability zone 21B.

The standby DB nodes 221B, 222B, and 223B include the DB programs 241B, 242B, and 243B, respectively. The DB program 241B is a primary DB program, while the DB programs 242B and 243B are secondary DB programs. While each of the DB nodes 221B, 222B, and 223B executes the corresponding one DB program according to the present example, the number of DB programs to be executed is not limited to one but may be more than one. According to the present example, the DB node 221B is also referred to as a primary DB node, while each of the DB nodes 222B and 223B is also referred to as a secondary DB node. For the waiting DB program (DB node), the number of primary DB programs is one, and the number of secondary DB programs is any number that is one or more.

The active storage nodes 231A, 232A, and 233A include active storage controllers 261A, 262A, and 263A, respectively, in the availability zone 21A.

The storage controller 261A generates a volume 251A, and provides the volume 251A for the DB node 221A (DB program 241A). The storage controller 262A generates a volume 252A, and provides the volume 252A for the DB node 222A (DB program 242A). The storage controller 263A generates a volume 253A, and provides the volume 253A for the DB node 223A (DB program 243A).

Each of the standby storage nodes 231B, 232B, and 233B operate without stopping in the availability zone 21B (hot standby). The standby storage nodes 231B, 232B, and 233B include standby storage controllers 261B, 262B, and 263B, respectively.

The storage controller 261B generates a volume 251B, and provides the volume 251B for the DB node 221B (DB program 241B). The storage controller 262B generates a volume 252B, and provides the volume 252B for the DB node 222B (DB program 242B). The storage controller 263B generates a volume 253B, and provides the volume 253B for the DB node 223B (DB program 243B).

The storage controller 261A of the storage node 231A stores update data in the volume 251A, and transfers copy data of the update data to the storage node 231B. The storage controller 261B of the storage node 231B stores the received copy data in the volume 251B.

The storage controller 262A of the storage node 232A stores update data in the volume 252A, and transfers copy data of the update data to the storage node 232B. The storage controller 262B of the storage node 232B stores the received copy data in the volume 252B.

The storage controller 263A of the storage node 233A stores update data in the volume 253A, and transfers copy data of the update data to the storage node 233B. The storage controller 263B of the storage node 233B stores the received copy data in the volume 253B.

As described above, data received from the client 211A and stored in the volume is made redundant by communication between the storage controllers (storage nodes). Moreover, the storage controllers in the storage cluster communicate with each other, and independently execute failover in a case of anomaly in the storage node. Note that a management server for the storage cluster may exist outside, and determine execution of failover. It is assumed in the following description that failover is independently executed in the storage cluster when the storage node causes a failure.

In a configuration example illustrated in FIG. 1C, all of the storage controllers in the availability zone 21B are waiting controllers. The availability zone 21B may include operating storage controllers as well as the standby controllers.

Discussed hereinafter as one example of a process according to the present example will be a process performed by the DB management system 1 when only the storage node 231A causes a failure. A process performed by a related art, which is not equipped with the DB management system 1, will first be touched upon.

As described above, the distributed DB system (DB cluster) and the distributed storage system (storage cluster) independently execute failover in the management target system 2. When the storage node 231A causes a failure, failover from the storage node 231A to the storage node 231B is executed in the storage cluster. As a result, the DB node 221A switches the access destination from the storage node 231A to the storage node 231B.

The DB node 221A is included in the availability zone 21A, while the storage node 231B corresponding to the destination of failover is included in the availability zone 21B. The DB node 221A is required to access the availability zone 21B different from the availability zone 21A including the DB node 221A. Accordingly, an access delay is produced.

When the DB management system 1 according to the present example detects a failure caused by only the storage node 231A, the DB management system 1 identifies the DB node 221A influenced by this failure, and excludes the DB node 221A from the DB cluster. For example, the DB management system 1 stops the DB node 221A, or gives an instruction of failover to a different DB node. In this manner, failover is executed within the DB cluster. Note that a stop instruction is one of failover instructions (instructions for executing failover). A failover instruction directly indicating a destination of failover may be created. This explanation regarding the stop instruction also applies to stop instructions discussed below.

Specifically, access from the client 211A to the DB node 221A is prohibited. The existing secondary DB nodes are switched to the primary DB nodes. For example, the secondary DB node 222A is switched to the primary DB node. The transmission destination of a write request from the client 211A is switched from the DB node 221A to the DB node 222A.

The secondary DB node 222A accesses the storage node 232A included in the same availability zone 21A. Accordingly, a response delay produced by access to the different availability zone can be eliminated.

In a different example, an instruction for stopping the DB node 222A is given when a failure is caused by only the storage node 232A. As a result, failover is executed within the DB cluster (DB replica set), and access from the client 211A to the DB node 222A is prohibited. A read request previously transmitted to the DB node 222A is transmitted to the DB node corresponding to the destination of failover, such as the DB node 223A. In this manner, a response delay produced after a failure caused by only the storage node can be reduced.

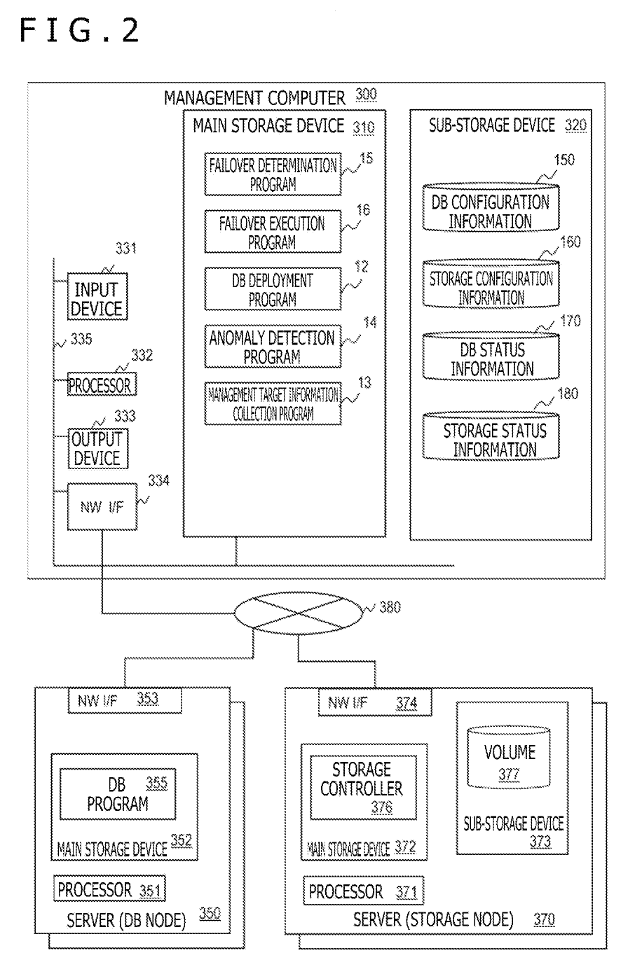

FIG. 2 illustrates a hardware configuration example of a computer system according to the present example. The DB management system 1 includes a management computer 300. The DB management system 1 may include a plurality of computers, and may use a virtualization technology such as a virtual machine and a container. The virtual machine or the container may be considered to include constituent elements of hardware resources to be used.

Described with reference to FIG. 2, the management computer 300 includes a processor (central processing unit (CPU), etc.) 332 which executes various programs, a main storage device (memory) 310 which stores various programs, and a sub-storage device 320 which stores various kinds of data. The processor 332 is allowed to include one or a plurality of cores, while the main storage device 310 is a dynamic random access memory (DRAM) which includes a volatile storage region or the like. For example, the sub-storage device 320 is a hard disk drive (HDD), a flash memory, or the like, and may be given a non-volatile storage region.

The management computer 300 further includes an output device 333 for presenting information to a user of this apparatus, an input device 331 operated by this user to input instructions, images, and the like, and a network interface (NW I/F) 334 for communicating with different devices. These components are connected to one another via a bus 335. The user may use a user terminal connected to the management computer 300 via a network instead of an input/output device of the management computer 300.

For example, function units of the management computer 300 may be implemented by the processor 332 operating in accordance with a program. The processor 332 reads various programs from the main storage device 310 as necessary, and executes these programs. The main storage device 310 is allowed to store programs and data used by the programs. For example, respective programs and reference data are loaded from the sub-storage device 320 to the main storage device 310, and executed and processed by the processor 332. Note that at least some of the function units may include logic circuits.

FIG. 2 illustrates a plurality of programs stored in the main storage device 310. These programs include the DB deployment program 12, the management target information collection program 13, the anomaly detection program 14, the failover determination program 15, and the failover execution program 16. FIG. 2 further illustrates management information stored in the sub-storage device 320. Specifically, the DB configuration information 150, the storage configuration information 160, the DB status information 170, and the storage status information 180 are stored in the sub-storage device 320.

The output device 333 includes devices such as a display, a printer, and a speaker. The input device 331 includes devices such as a keyboard, a mouse, and a microphone. The output device 333 presents a result of input from the user and a result of processing performed by the management computer 300. An instruction is input from the user to the management computer 300 by use of the input device 331. In a case of a configuration using a user terminal, an input/output device included in the user terminal performs similar functions. Accordingly, the output device 333 and the input device 331 may be eliminated.

For example, the network interface 334 receives data transmitted from the management target system 2 connected via a network 380, and also transmits instructions given from the management computer 300 to the management target system 2.

In the configuration example illustrated in FIG. 2, each of DB nodes includes one server 350 (hardware computer). Alternatively, the DB nodes may be constructed using a virtualization technology as described above. The server 350 may include constituent elements similar to those of the management computer 300. FIG. 2 illustrates a processor 351, a main storage device 352, and a network interface 353 as examples of these constituent elements. The main storage device 352 stores a DB program 355. The DB program 355 is one of the DB programs illustrated in FIG. 1C.

In the configuration example illustrated in FIG. 2, each of the storage nodes includes one server 370 (hardware computer). As described above, the storage nodes may also be constructed using a virtualization technology. The server 370 may include constituent elements similar to those of the management computer 300. FIG. 2 illustrates a processor 371, a main storage device 372, a sub-storage device 373, and a network interface 374 as examples of these constituent elements.

The main storage device 372 stores a storage controller 376 as a program. The storage controller 376 is one of the storage controllers illustrated in FIG. 1C. Meanwhile, the sub-storage device 373 includes a volume 377. The volume 377 is one of the volumes illustrated in FIG. 1C.

The respective functions of the DB management system 1, the DB node, and the storage node may be implemented by software operating in a general-purpose computer, dedicated hardware, or a combination of software and hardware. Respective processes performed by respective processing units (operation entities) in a program described in the examples of the present specification may be considered as processes performed by a processor, or a device or a system including this processor.

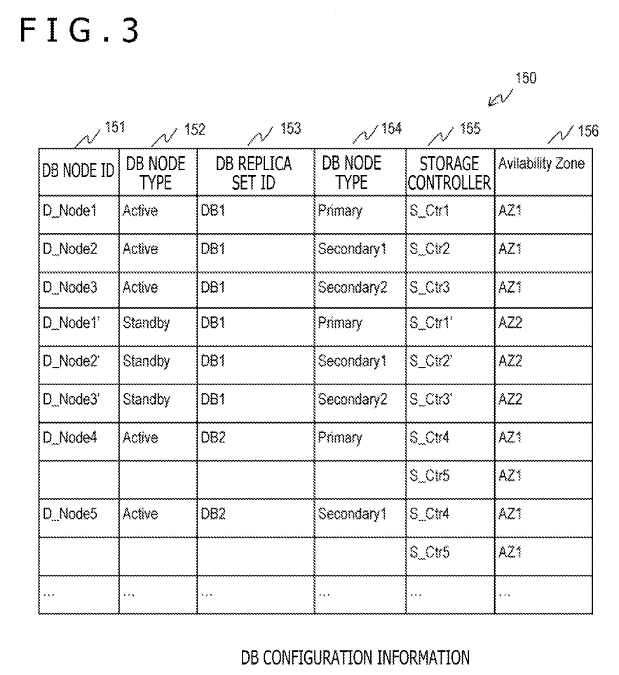

FIG. 3 illustrates a configuration example of the DB configuration information 150. The DB configuration information 150 manages information associated with the DB node. The DB configuration information 150 includes a DB node ID column 151, a DB node type column 152, a DB replica set ID column 153, a DB node type column 154, a storage controller column 155, and an availability zone column 156.

The DB node ID column 151 indicates an ID for identifying the DB node. The DB node type column 152 indicates an operating (active) type or a waiting (standby) type in a steady state of the DB node. The standby DB node may be either stopped (cold standby) or started (hot standby). The cold standby can reduce power consumption and costs in a cloud.

The DB replica set ID column 153 indicates an ID for identifying a DB replica set to which the DB node belongs. The DB replica set is a group of DB nodes handling the same data, and is a DB cluster including the active DB node and the standby DB node. The DB node type column 154 indicates a primary type or a secondary type of the DB node.

The storage controller column 155 indicates an ID for identifying the controller (active) of the storage node storing data of the DB node. One or a plurality of storage nodes store data of one DB node. For example, data of a DB node D_Node4 is stored and managed by two storage controllers S_Ctr4 and S_Ctr5. The availability zone column 156 indicates an ID for identifying the AZ containing the DB node.

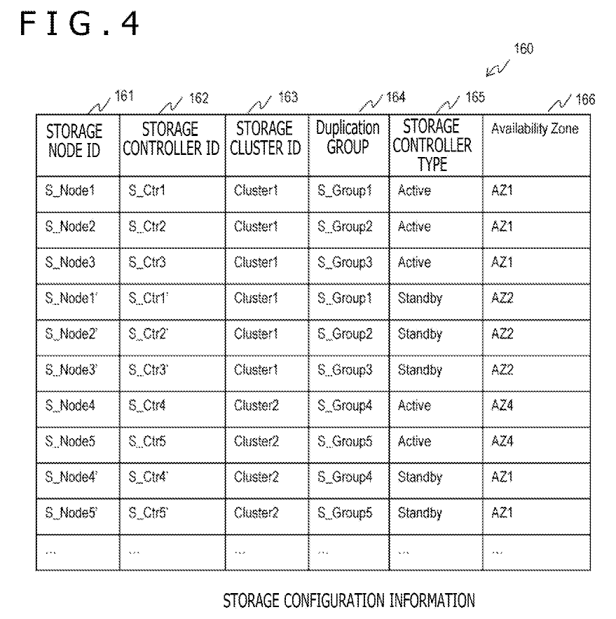

FIG. 4 illustrates a configuration example of the storage configuration information 160. The storage configuration information 160 manages information associated with storage nodes. The storage configuration information 160 includes a storage node ID column 161, a storage controller ID column 162, a storage cluster ID column 163, a duplication group ID column 164, a storage controller type column 165, and an availability zone column 166.

The storage node ID column 161 indicates an ID for identifying the storage node. The storage controller ID column 162 indicates an ID for identifying the storage controller executed by the storage node. The storage cluster ID column 163 indicates an ID for identifying the storage cluster containing the storage node.

The duplication group ID column 164 indicates an ID for identifying the group of storage nodes storing the same data by mirroring. The storage controller type column 165 indicates an operating (active) type or a waiting (standby) type of the storage node. For example, the standby type includes hot standby.

The active storage node transmits copy data of write data received from the DB node to the standby storage node in the duplication group. The standby storage node stores the received copy data in the volume.

The availability zone column 166 indicates an ID for identifying the availability zone containing the storage node.

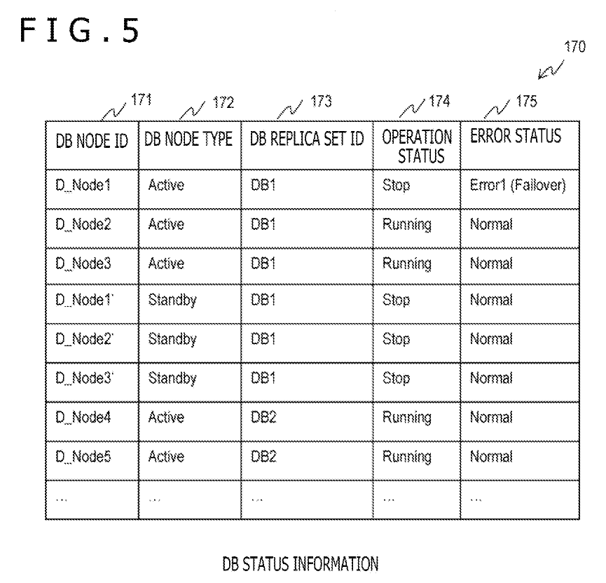

FIG. 5 illustrates a configuration example of the DB status information 170. The DB status information 170 manages the status of the DB node. The DB status information 170 includes a DB node ID column 171, a DB node type column 172, a DB replica set ID column 173, an operation status column 174, and an error status column 175.

The DB node ID column 171, the DB node type column 172, and the DB replica set ID column 173 are identical to the DB node ID column 151, the DB node type column 152, and the DB replica set ID column 153 of the DB configuration information 150, respectively.

The operation status column 174 indicates the operation status of each of the DB nodes. Specifically, the operation status column 174 indicates whether the DB node is stopped or operating. The error status column 175 indicates whether the DB node is in an error status, or a normal status where normal operation is achievable. The error type of the current error is also indicated for the DB node in the error status. For example, the standby DB node is stopped. Moreover, when the operating active DB node causes a specific error, this active DB node stops. However, the DB node may operate depending on the error type.

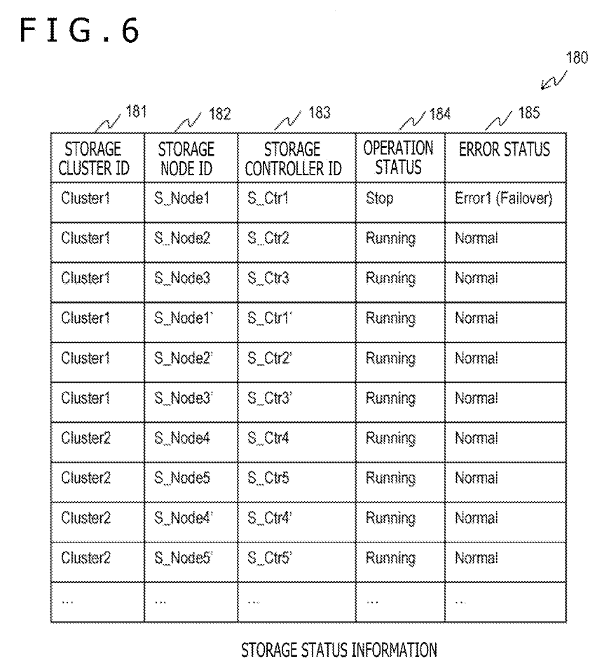

FIG. 6 illustrates a configuration example of the storage status information 180. The storage status information 180 manages the status of the storage node. The storage status information 180 includes a storage cluster ID column 181, a storage node ID column 182, a storage controller ID column 183, an operation status column 184, and an error status column 185. The storage cluster ID column 181, the storage node ID column 182, and the storage controller ID column 183 are identical to the storage cluster ID column 163, the storage node ID column 161, and the storage controller ID column 162 of the storage configuration information 160, respectively.

The operation status column 184 indicates the operation status of each of the storage nodes. Specifically, the operation status column 184 indicates whether the storage node is stopped or operating. The error status column 185 indicates whether the storage node is in an error status, or a normal status where normal operation is achievable. The error type of the current error is also indicated for the storage node in the error status. When the operating active storage node causes a specific error, this active storage node stops. However, the storage node may operate depending on the error type.

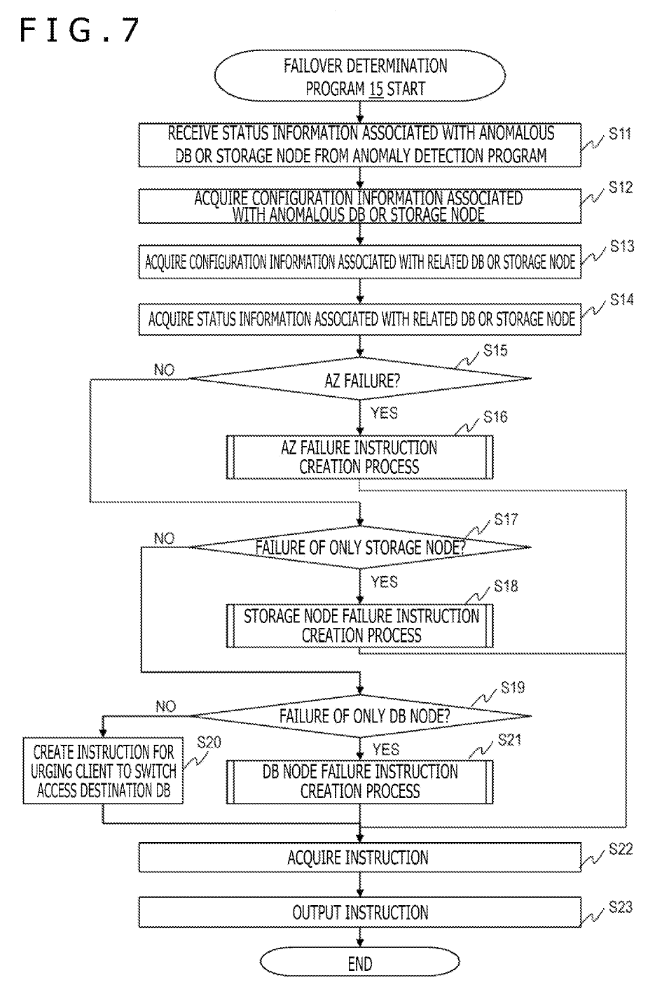

FIG. 7 is a flowchart illustrating an example of a process performed by the failover determination program 15. FIG. 7 illustrates a process carried out at the time of reception of one status information associated with an anomalous DB or storage node. If a plurality of anomalies are caused, the process illustrated in FIG. 7 is repeatedly executed.

The failover determination program 15 receives status information associated with the anomalous DB or storage node from the anomaly detection program 14 (S11). The anomaly detection program 14 determines presence or absence of anomaly with reference to the DB status information 170 and the storage status information 180. The anomalous DB or storage node is a DB or storage node causing a predetermined error. The status information may be a corresponding entry of the DB status information 170 or the storage status information 180.

Subsequently, the failover determination program 15 acquires configuration information associated with the anomalous DB or storage node from the DB configuration information 150 or the storage configuration information 160 (S12).

Moreover, the failover determination program 15 acquires configuration information associated with the DB or storage nodes related to the anomalous DB or storage node from the DB configuration information 150 and the storage configuration information 160 (S13). The related DB or storage nodes are nodes whose configuration information will be referred to in the following process. For example, these nodes may include storage nodes storing data of the DB nodes, DB nodes of the same replica set, storage nodes storing data of these DB nodes, DB nodes storing data of the storage nodes, storage nodes included in the same duplication group, and DB nodes storing data of these storage nodes.

Further, the failover determination program 15 acquires status information associated with the related DB and storage nodes from the DB status information 170 and the storage status information 180 (S14).

Next, the failover determination program 15 determines whether an AZ failure has been caused (S15). When this failure occurs, the whole of the availability zone to which the DB or storage node causing anomaly detected in step S11 belongs becomes unavailable.

The failover determination program 15 determines that an AZ failure has been caused when any one of several determination criteria including the following determination criteria is met. One of the criteria is that none of the DB or storage nodes included in the same DB replica set as that of the DB or storage node causing the detected anomaly and within the same availability zone gives a response (this situation is also considered as an error).

Another criterion is that all of the DB or storage nodes included in the same DB replica set as that of the DB or storage node causing the detected anomaly and within the same availability zone can give responses, but are in a specific error status. A further criterion is that none of combinations of the DB node and the storage node included in the same DB replica set as that of the DB or storage node causing the detected anomaly and within the same availability zone gives a response, or are in a specific error status. The combinations of the DB node and the storage node are combinations of the DB node and the storage node storing data of this DB node.

In addition, presence or absence of an AZ failure can be determined on the basis of a network failure or the like. Note that a similar determination process may be executed for a failure in a region containing one or more availability zones. Determination of a region failure may be executed before determination of an AZ failure, or only determination of a region failure may be made in place of determination of a failure for each AZ.

In a case where an AZ failure has been caused (S15: YES), the failover determination program 15 executes an AZ failure instruction creation process (S16). The AZ failure instruction creation process S16 will be detailed below. Note that a region failure instruction creation process similar to the process S16 may be executed for determining a region failure.

In a case where no AZ failure has been caused (S15: NO), the failover determination program 15 determines whether a failure of only the storage node has been caused (S17). In a case where a failure of only the storage node has been caused (S17: YES), the failover determination program 15 executes a storage node failover instruction creation process (S18).

In a case where the normal DB node stores data in the storage node causing detected anomaly, the failover determination program 15 executes the storage node failure instruction creation process S18. For example, in a case where a failure of only the storage node 231A has been caused, or where a failure of only the storage node 232A has been caused in the configuration example in FIG. 1C, the storage node failure instruction creation process S18 is executed. The storage node failure instruction creation process S18 will be detailed below.

In a case where the current failure is not a failure of only the storage node (S17: NO), the failover determination program 15 determines whether a failure of only the DB node has been caused (S19). For example, in a case where the node causing detected anomaly is the DB node, or where a failure of the DB node which accesses the storage node causing detected anomaly has been caused (S17: NO), the failover determination program 15 determines whether a failure of only the DB node has been caused (S19).

In a case where a failure of only the DB node has been caused (S19: YES), the failover determination program 15 executes a DB node failure instruction creation process (S21), and advances the flow to step S22. For example, in a case where the normal storage node stores data in the DB node causing detected anomaly, the failover determination program 15 executes the DB node failure instruction creation process. The DB node failure instruction creation process S21 will be detailed below. For example, in a case where a failure of only the DB node 221A has been caused in the configuration example in FIG. 1C, the DB node failure instruction creation process S21 is executed.

In a case where the current failure is not a failure of only the DB node (S19: NO), the failover determination program 15 creates an instruction for urging the client to switch the access destination DB node (S20), and advances the flow to step S22. For example, in a case where failures of both the DB node and the storage node accessed by the DB node have been caused, the failover determination program 15 creates a null instruction.

In step S22, the failover determination program 15 acquires the created instruction, and then outputs the acquired instruction to the failover execution program 16 or to the output device 333 to present the instruction to the manager (S23). In this case, the instruction presented to the manager may be transmitted to the management target system 2 by the manager rather than by the DB management system 1.

As described above, it is determined which of the availability zone, the storage node, and the DB node causes a failure corresponding to anomaly, and an instruction is created according to a result of this determination. In this manner, more appropriate management and control of the management target system 2 is achievable. Note that the process in FIG. 7 has been presented only by way of example. Determination of a position of a failure causing anomaly and creation of an instruction corresponding to this determination may be achieved by other methods.

When a plurality of anomalies to be processed in accordance with the flow in FIG. 7 are detected in one example of the present specification, the failover determination program 15 gives priority to processing of anomaly of the storage node. In a case where failures of the DB node and the storage node not paired with each other have been caused (and not a case of an AZ failure) in the presence of a plurality of anomalies caused in the same replica set, processing of the anomaly of the storage node first is considered to be more efficient. Specifically, if the DB node is switched to the destination DB node first, the anomaly of the storage node may stop the destination DB node.

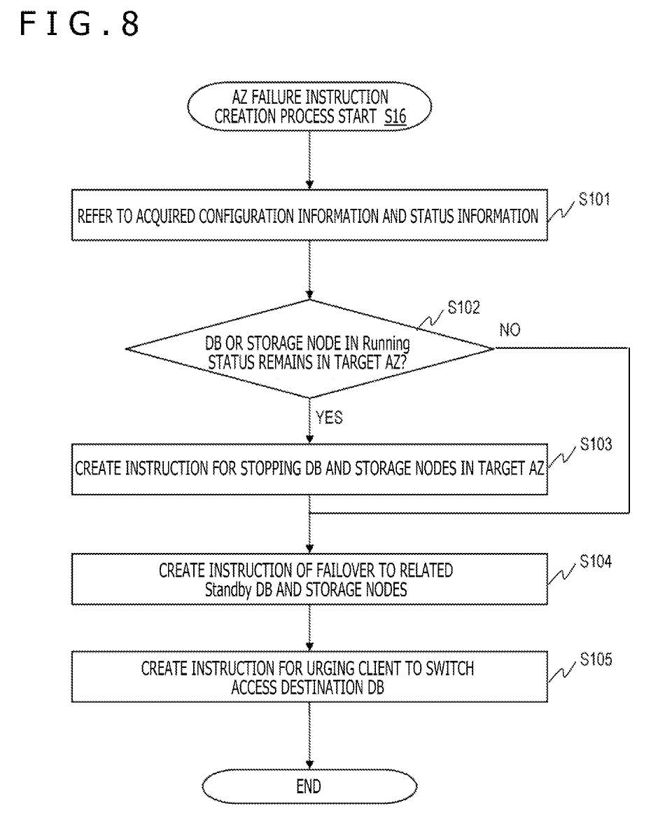

FIG. 8 is a flowchart illustrating an example of the AZ failure instruction creation process S16. Note that a region failure instruction creation process similar to the process S16 may be executed for determining a region failure. The AZ failure instruction creation process S16 creates an instruction for carrying out failover from the active availability zone to the standby availability zone. For example, failover from the availability zone 21A to the availability zone 21B is achieved in the configuration example in FIG. 1C.

The failover determination program 15 refers to acquired configuration information and status information (S101). The failover determination program 15 determines whether the DB or storage node in a “running” operation status remains in the target availability zone causing an AZ failure (S102).

In a case where the DB or storage node in the “running” operation status remains (S102: YES), the failover determination program 15 creates an instruction for stopping the DB nodes and the storage nodes in the target availability zone causing the AZ failure (S103). Note that an instruction of exclusion from the DB replica set or the storage cluster may be issued instead of the instruction of a stop of the nodes.

In a case where no DB or storage node in the “running” operation status remains (S102: NO), or after processing in step S103, the failover determination program 15 creates an instruction of failover to the related standby DB or storage nodes (S104). For example, an instruction of failover to all of the DB nodes and the storage nodes in the availability zone 21B is created in the configuration example illustrated in FIG. 1C.

Moreover, the failover determination program 15 creates an instruction for urging the client to switch the access destination DB node (S105). Note that the access destination may be switched by use of a load balancer or a switching device provided between the client and the DB nodes. After completion of failover, the DB node type and the storage controller type in the configuration information and the status information are updated. This applies to failover in different modes.

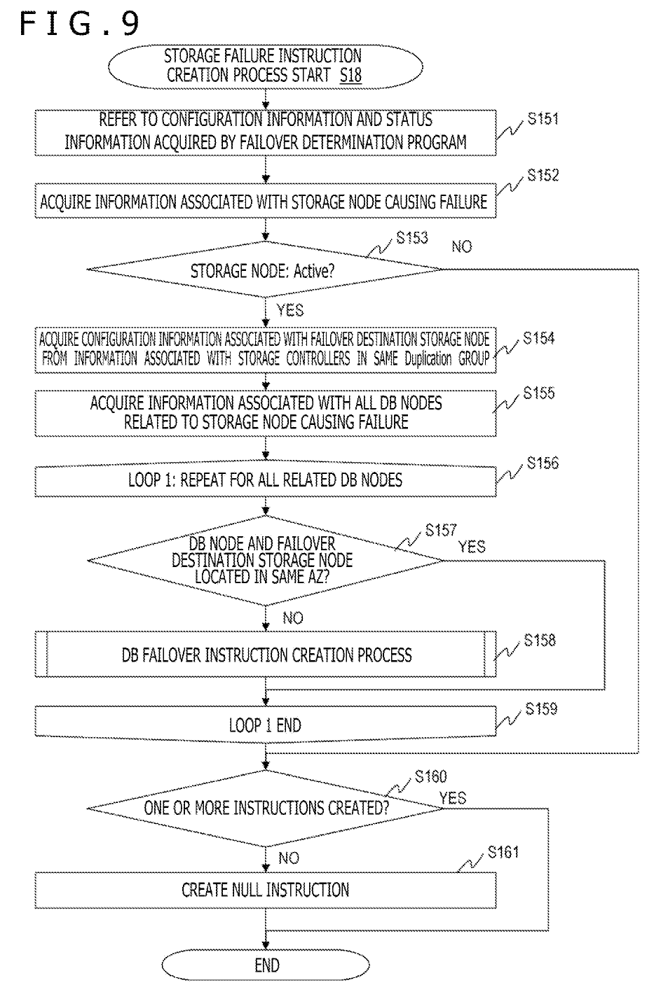

FIG. 9 is a flowchart illustrating an example of the storage node failure instruction creation process S18. For example, in a case of a failure of only the storage node 231A, or a failure of only the storage node 232A (failure of only storage node) in the configuration example in FIG. 1C, the storage node failure instruction creation process S18 is executed.

The failover determination program 15 refers to acquired configuration information and status information (S151). The failover determination program 15 acquires information associated with the storage node causing a failure from the information referring to (S152).

Subsequently, the failover determination program 15 determines whether the storage controller type of the storage node causing the failure is active (S153). In a case where the storage controller type is not active but standby (S153: NO), the flow proceeds to step S160.

In a case where the storage controller type is active (S153: YES), the failover determination program 15 acquires configuration information associated with the failover destination storage node from information associated with the storage controllers included in the same duplication group (S154). For example, the failover destination of the storage node 231A is the storage node 231B in the configuration example in FIG. 1C.

For example, in a case where failover between the storage nodes has already been completed, configuration information associated with the storage node which executes the storage controller active in the same duplication group is acquired. Failover between the storage nodes is executed using a known technology relating to storage nodes. Accordingly, this failover is not explained in detail in the present specification.

In a case where failover is not completed, the failover determination program 15 may specify the failover destination by a mechanism of failover between the storage nodes, or wait until a change of the different storage nodes in the same duplication group to active nodes after a predetermined waiting time.

Subsequently, the failover determination program 15 acquires information associated with all of the DB nodes related to the storage node causing the failure (S155). The related DB nodes are DB nodes which access a volume provided by the corresponding storage node, and are indicated in the DB configuration information 150. For example, the DB node related to the storage node 231A is the DB node 221A in the configuration example in FIG. 1C. While one DB node is related to one storage node in the example in FIG. 1C, a plurality of DB nodes may be related to one storage node. Conversely, a plurality of storage nodes may be related to one DB node.

Next, the failover determination program 15 sequentially selects all of the related DB nodes, and repetitively executes steps S156 through S159. First, the failover determination program 15 determines whether the DB node and the failover destination storage node are located in the same availability zone (S157).

In a case where the DB node and the failover destination storage node are located in the same availability zone (S157: YES), the loop for this DB node ends. In a case where the DB node and the failover destination storage node are not located in the same availability zone (S157: NO), the failover determination program 15 executes a DB failover instruction creation process (S158).

For example, the storage node 231B corresponding to the failover destination of the storage node 231A and the DB node 221A related to the storage node 231A are located in the different availability zones in the configuration example in FIG. 1C. Accordingly, the DB failover instruction creation process S158 is executed.

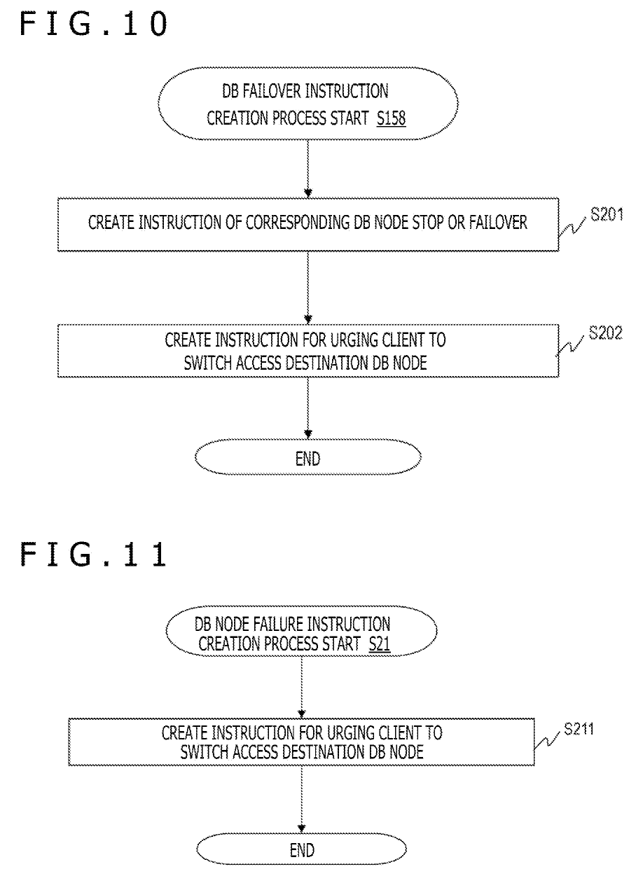

FIG. 10 is a flowchart illustrating an example of the DB failover instruction creation process S158. The failover determination program 15 creates an instruction of a stop or failover of the corresponding DB node (S201). Failover requires a switching time ranging from several seconds to several tens of seconds. Accordingly, this instruction may be created in a period in which the number of accesses is smaller than a threshold. Alternatively, it may be checked whether the storage node causing a failure is immediately recovered, and an instruction of failover may be created if such recovery is difficult. For example, a restart of the storage node may be attempted to check recovery.

For example, a stop or failover of the DB node 221A related to the storage node 231A causing a failure is created in the configuration example in FIG. 1C. When the primary DB node 221A stops, the secondary DB node in the same DB replica set, such as the DB node 222A, is changed to the primary DB node by the function of the DB system. Failover is executed between the active DB nodes in the same DB replica set. In response to the stop or the failover of the secondary DB node, the access to this secondary DB node is switched to access a different secondary or primary DB node.

Next, the failover determination program 15 creates an instruction for urging the client to switch the access destination DB node (S202). Note that a load balancer or a switching device disposed between the client and the DB node may be switched instead of issuing the instruction to the client.

In a case where a plurality of regions each including one or more availability zones are defined and a considerable access delay is not produced even at the time of access to the different availability zone within the same region, an instruction of DB failover may be issued not for access within the same region, but only for access to the different region.

Described with reference to FIG. 9 again, the failover determination program 15 determines whether one or more instructions have been created after completion of processing from steps S156 through S159 for all of the related DB nodes (S160). In a case where no instruction has been created (S160: NO), the failover determination program 15 creates a null instruction (S161). If instructions have already been created (S160: YES), the present flow ends.

FIG. 11 is a flowchart illustrating an example of the DB node failure instruction creation process S21. The failover determination program 15 creates an instruction for urging the client to switch the access destination DB node (S211), and ends the present flow. When the DB node causes a failure, necessary failover is executed between the active DB nodes within the same DB replica set as described above.

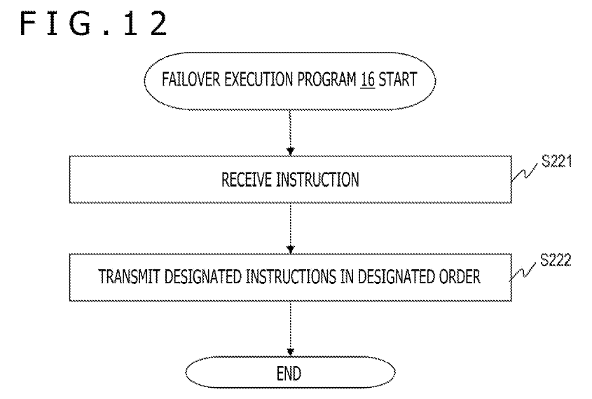

FIG. 12 is a flowchart illustrating an example of a process performed by the failover execution program 16. The failover execution program 16 receives instructions issued from the manager to the management target system 2 via the failover determination program 15 or the input device 331 (S221). The failover execution program 16 transmits the designated instructions to the management target system 2 in a designated order (S222).

### Example 2

In the present example, the number of operating secondary DB nodes is adjusted to a predetermined number or more in the DB failover instruction creation process performed in the storage node failure instruction creation process S18. For example, the predetermined number may be one or the number of existing DB nodes. Maintaining the predetermined number or larger includes maintaining the predetermined number at the number of existing DB nodes or larger. In this manner, deterioration of read performance within the system can be reduced. Differences from example 1 will hereinafter mainly be discussed. Unless specified otherwise, the description of example 1 can be applied to the present example.

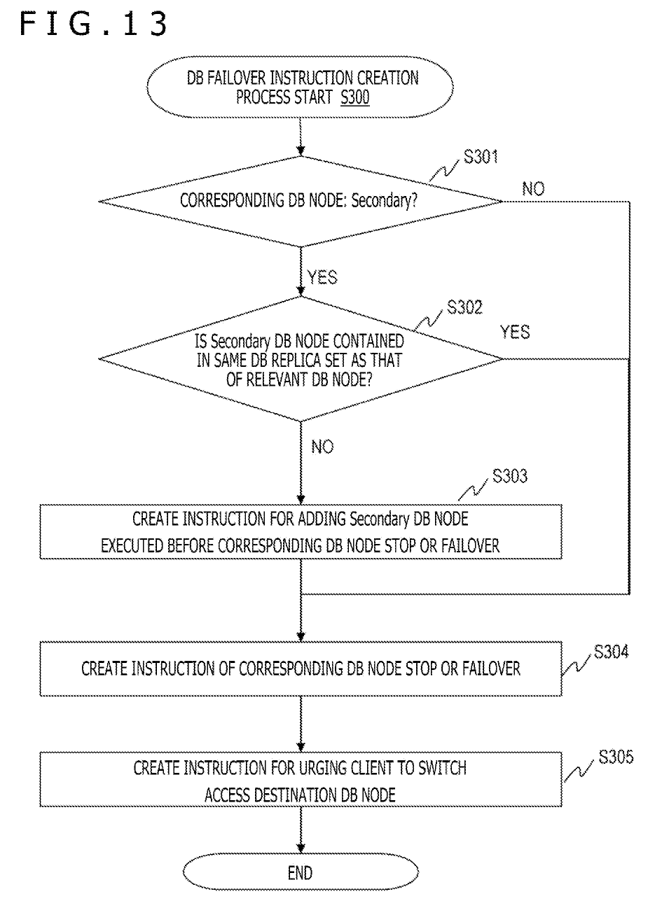

FIG. 13 is a flowchart illustrating a failover instruction creation process S300 according to the present example. The failover instruction creation process S300 corresponds to the failover instruction creation process S158 in example 1. According to the example discussed hereinbelow, the number of secondary DB nodes is controlled such that at least one secondary DB node is operable for a failure of the secondary DB node.

First, the failover determination program 15 determines whether the type of the DB node accessing the storage node causing a failure is secondary (S301). In a case where the type of the DB node is not secondary, i.e., is primary (S301: NO), the flow proceeds to step S304.

In a case where the type of the DB node is secondary (S301: YES), the failover determination program 15 determines whether a different secondary DB node is included in the DB replica set containing the relevant DB node (S302). This determination is executed for the active DB nodes.

In a case where a different secondary DB node is present (S302: YES), the flow proceeds to step S304. In a case where a different secondary DB node is absent (S302: NO), the failover determination program 15 creates an instruction for adding a secondary DB node executed before a stop or failover of the target secondary DB node (S303). Note that the storage node to be accessed by the corresponding secondary DB node may be added at the time of addition of the secondary DB node.

Moreover, the failover determination program 15 creates an instruction of a stop or failover of the target secondary DB node (S304). For example, a stop or failover of the target secondary DB node is executed after a start of operation of the added nodes. Finally, the failover determination program 15 creates an instruction for urging the client to switch the access destination DB node (S305).

For example, suppose that the storage node 232A causes a failure in the absence of a combination of the DB node 223A and the storage node 233A in the configuration example in FIG. 1C. In this case, the DB node 222A is stopped, and the combination of the DB node 223A and the storage node 233A is added according to the present example.

In a different configuration example, step S302 may be eliminated. In this case, the number of secondary DB nodes is maintained. According to a different configuration example, a new secondary DB node may be added after failover when the target DB node is a primary node.

In a case where performance of different secondary DB nodes which are actually present is determined to be insufficient, or where free resources of the remaining secondary DB nodes are determined to be insufficient in regard to a previous access volume of the target secondary DB node, the failover determination program 15 may determine “NO” in step S302.

In the configuration example illustrated in FIG. 13, a combination of the secondary DB node and the storage node is added. In a different configuration example, a volume for the newly added secondary DB node may be created for the existing storage node. For example, suppose that the storage node 232A causes a failure in the absence of a combination of the DB node 223A and the storage node 233A in the configuration example in FIG. 1C. In this configuration example, the DB node 222A is stopped, the DB node 223A is added, and an access destination volume of the DB node 223A is created for the storage node 231A.

### Example 3

A distributed database combining a DB replica set and sharding will be discussed in the present example. Sharding divides a table into a plurality of shards (data sets), distributes the shards to a plurality of storage nodes, and stores the respective shards in the corresponding storage nodes. Differences from example 1 will hereinafter mainly be discussed. Unless specified otherwise, the description of example 1 can be applied to the present example.

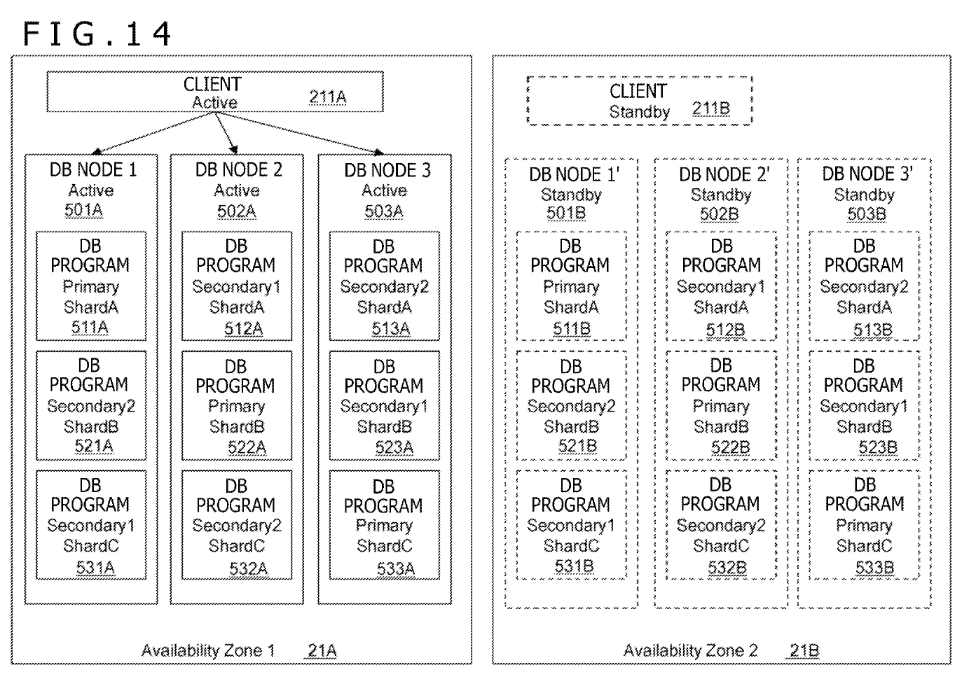

FIG. 14 illustrates a configuration example of DB nodes according to the present example. In comparison with the configuration example illustrated in FIG. 1C, the active client 211A accesses active DB nodes 501A, 502A, and 503A in the availability zone 21A instead of the active DB nodes 221A, 222A, and 223A.

In addition, the standby client 211B accesses standby DB nodes 501B, 502B, and 503B in the availability zone 21B instead of the standby DB nodes 221B, 222B, and 223B.

Each of the DB nodes executes a plurality of DB programs managing different shards. One primary DB program and one or more secondary DB programs are executed for each shard. In the configuration example illustrated in FIG. 14, the primary DB programs of different shards are executed by different DB nodes. The DB node executing the primary DB program of each shard is the primary DB node of this shard, while the DB node executing the secondary DB program of this shard is the secondary DB node of this shard.

The active DB node 501A executes a primary DB program 511A of a shard A, a secondary DB program 521A of a shard B, and a secondary DB program 531A of a shard C.

The active DB node 502A executes a secondary DB program 512A of the shard A, a primary DB program 522A of the shard B, and a secondary DB program 532A of the shard C.

The active DB node 503A executes a secondary DB program 513A of the shard A, a secondary DB program 523A of the shard B, and a primary DB program 533A of the shard C.

The standby DB node 501B executes a primary DB program 511B of the shard A, a secondary DB program 521B of the shard B, and a secondary DB program 531B of the shard C.

The standby DB node 502B executes a secondary DB program 512B of the shard A, a primary DB program 522B of the shard B, and a secondary DB program 532B of the shard C.

The standby DB node 503B executes a secondary DB program 513B of the shard A, a secondary DB program 523B of the shard B, and a primary DB program 533B of the shard C.

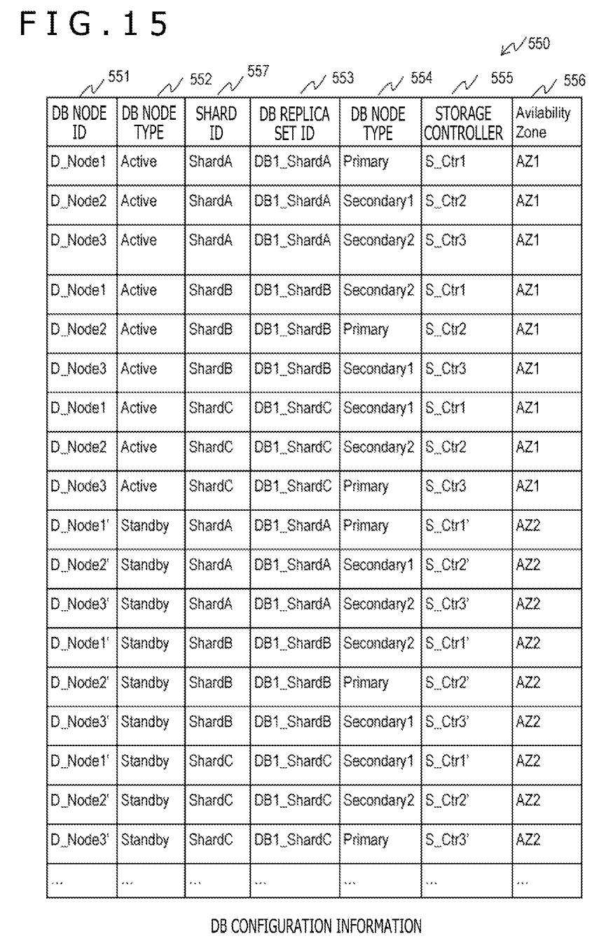

FIG. 15 illustrates a configuration example of DB configuration information 550 according to the present example. The DB configuration information 550 corresponds to the DB configuration information 150 in example 1. The DB configuration information 550 includes a DB node ID column 551, a DB node type column 552, a DB replica set ID column 553, a DB node type column 554, a storage controller column 555, an AZ column 556, and a shard ID column 557.

The respective columns other than the DB replica set ID column 553 and the shard ID column 557 are similar to the corresponding columns included in the DB configuration information 150 in FIG. 3 and given the same names. The shard ID column 557 indicates an ID for identifying the shard. The DB replica set ID column 553 indicates an ID for identifying a DB replica set. The DB replica set is defined for each shard. One DB replica set ID is defined for each combination of the DB node and the shard.

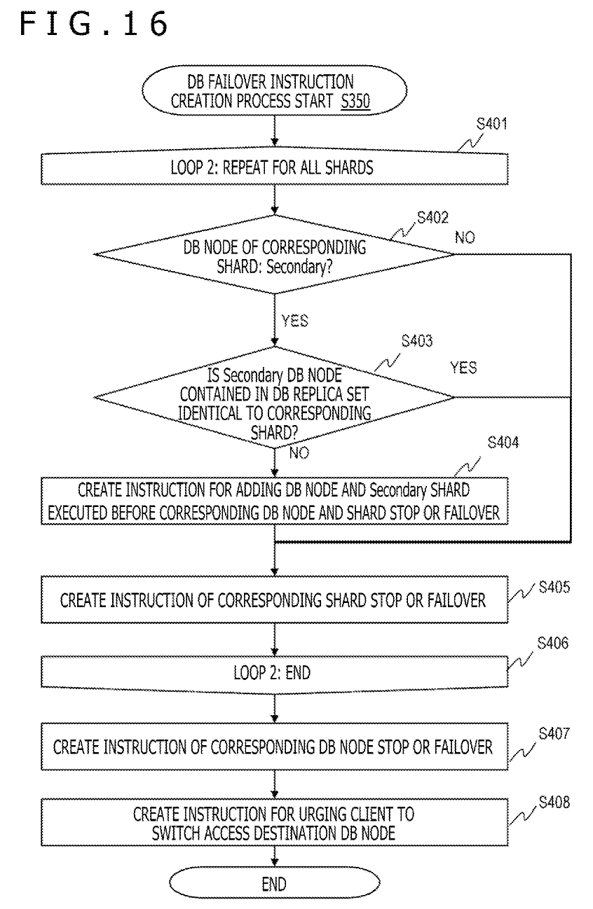

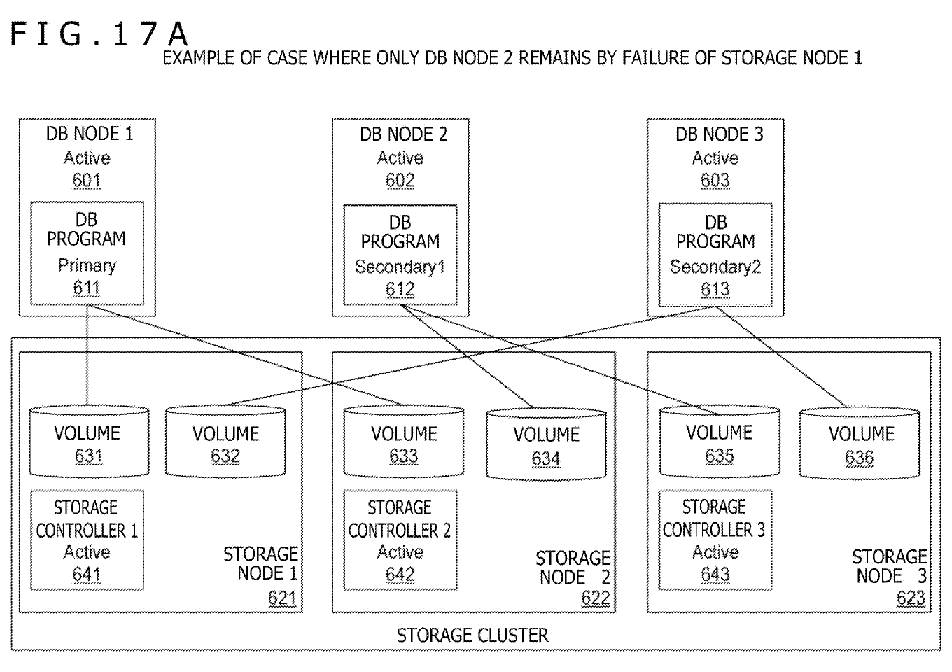

FIG. 16 is a flowchart illustrating a DB failover instruction creation process S350 according to the present example. This process is executed in the storage node failure instruction creation process 18 illustrated in FIG. 9. The DB failover instruction creation processes S158 and S300 of examples 1 and 2 are executed for the respective related DB nodes. The DB failover instruction creation process S350 of the present example is executed for the respective shards at the respective DB nodes.

Discussed here will be an example of the DB failover instruction creation process S300 of example 2 applied to a distributed DB system performing sharding. Unless specified otherwise, the explanation given with regard to the DB node with reference to FIG. 13 can be applied to the shard. Described with reference to FIG. 16, the failover determination program 15 repetitively executes steps S401 through S406 for the different shards of the DB node sequentially selected.

First, the failover determination program 15 determines whether the type of the DB node of the current shard is secondary (S402). In a case where the type of the DB node is not secondary, i.e., is primary (S402: NO), the flow proceeds to step S405.

In a case where the type of the DB node is secondary (S402: YES), the failover determination program 15 determines whether a different secondary DB node is present in the DB replica set containing the relevant shard (S403). This determination is executed for the active DB nodes.

In a case where a different secondary DB node is present (S403: YES), the flow proceeds to step S405. In a case where a different secondary DB node is absent (S403: NO), the failover determination program 15 creates an instruction for adding the DB node and the shard executed before a stop or failover of a combination of the target DB node and the target shard (S404). Note that a volume (of the new or existing storage node) to be accessed by the added DB node is also added at the time of addition of the DB node.

Note that step S403 may be eliminated. When the target DB node is a primary node, a new secondary DB node may be added after failover. In a case where performance of the different secondary DB nodes which are actually present is determined to be insufficient, or where free resources of the remaining secondary DB nodes is determined to be insufficient with respect to a previous access volume of the target secondary DB node, the failover determination program 15 may determine “NO” in step S403.

Moreover, the failover determination program 15 creates an instruction of a stop or failover of the target DB node (S407). Finally, the failover determination program 15 creates an instruction for urging the client to switch the access destination DB node (S408).

For example, suppose that the DB node 501A is stopped in response to a failure of only the storage node in the absence of the DB node 503A and the shard C in the configuration example in FIG. 14. The DB program 521A is the one and only secondary DB program of the shard B. A new DB node for executing the secondary DB program of the shard B is added.

The DB program 511A of the shard A of the DB node 501A is a primary program. The secondary DB program 512A of the shard A of the DB node 502A is switched to a primary DB program. A DB node newly added also executes the secondary DB program of the shard A.

### Example 4

An arrangement method (arrangement rule) of DB nodes (DB programs) will be discussed in the present example. DB nodes are arranged in accordance with a predetermined rule during construction of a DB cluster or addition of DB nodes. According to the present embodiment, a DB node arrangement is determined such that the number of DB nodes sharing a storage node becomes a predetermined value designated beforehand or smaller. This configuration can reduce the number of failover-target DB nodes for handling failures of storage nodes.

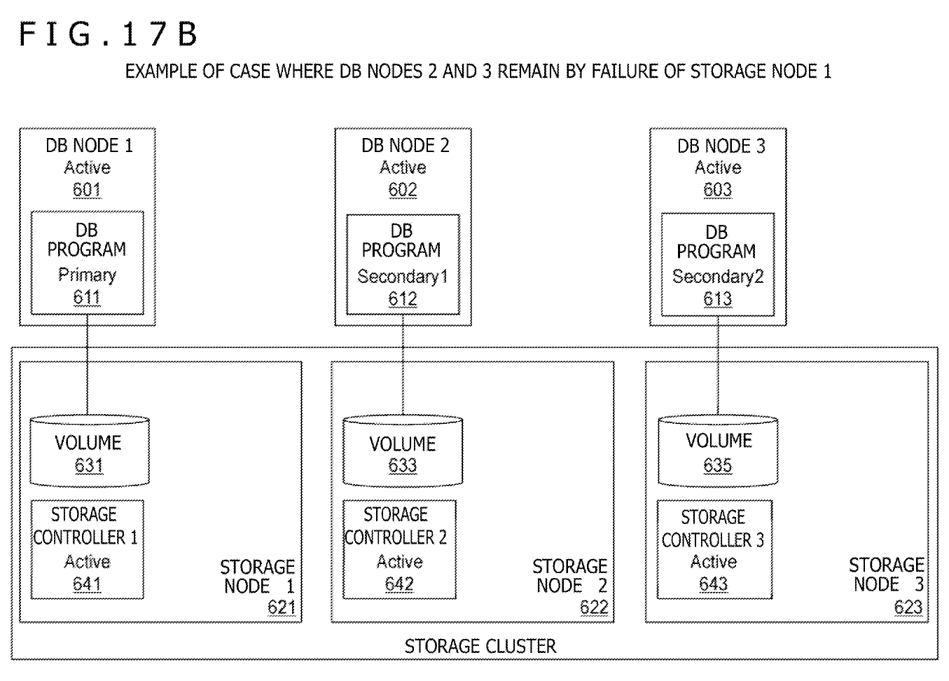

Each of FIGS. 17A and 17B illustrates an example of a layout of DB nodes and access destination volumes of the DB nodes. In the configuration example of FIG. 17A, DB nodes 601, 602, and 603 are contained in the same DB cluster (DB replica set). The DB node 601 executes a primary DB program 611. The DB node 602 executes a secondary DB program 612. The DB node 603 executes a secondary DB program 613.

Active storage nodes 621, 622, and 623 are contained in the same storage cluster. The storage node 621 executes a storage controller 641, and stores two volumes 631 and 632. The storage node 622 executes a storage controller 642, and stores two volumes 633 and 634. The storage node 623 executes a storage controller 644, and stores two volumes 635 and 636.

The DB node 601 accesses the two volumes 631 and 633 belonging to the different storage nodes. The DB node 602 accesses the two volumes 634 and 635 belonging to the different storage nodes. The DB node 603 accesses the two volumes 632 and 636 belonging to the different storage nodes. For example, data processed by the DB node 601 is distributed to and stored in the two volumes 631 and 633. Similarly, data processed by the DB node 602 is distributed to and stored in the two volumes 634 and 635, while data processed by the DB node 603 is distributed to and stored in the two volumes 632 and 636. Note that the volume accessed by one DB node may be stored in the same storage node.

The volumes 632, 634, and 636 illustrated in the configuration example in FIG. 17A are removed from the configuration example in FIG. 17B. Accordingly, one volume is accessed by each of the DB nodes. In the configuration example illustrated in FIG. 17A, only the DB node 602 remains without a stop or failover at the time of a failure of the storage node 621. Meanwhile, in the configuration example illustrated in FIG. 17B, the DB nodes 602 and 603 remain without a stop or failover at the time of a failure of the storage node 621.

In comparison with the configuration example in FIG. 17A, an initial arrangement of the DB nodes in the configuration example in FIG. 17B is determined such that the number of DB nodes sharing the storage nodes decreases. Specifically, the sharing number is one in the configuration example in FIG. 17A, while the sharing number is zero in the configuration example in FIG. 17B. In this manner, the number of failover-target DB nodes can be reduced.

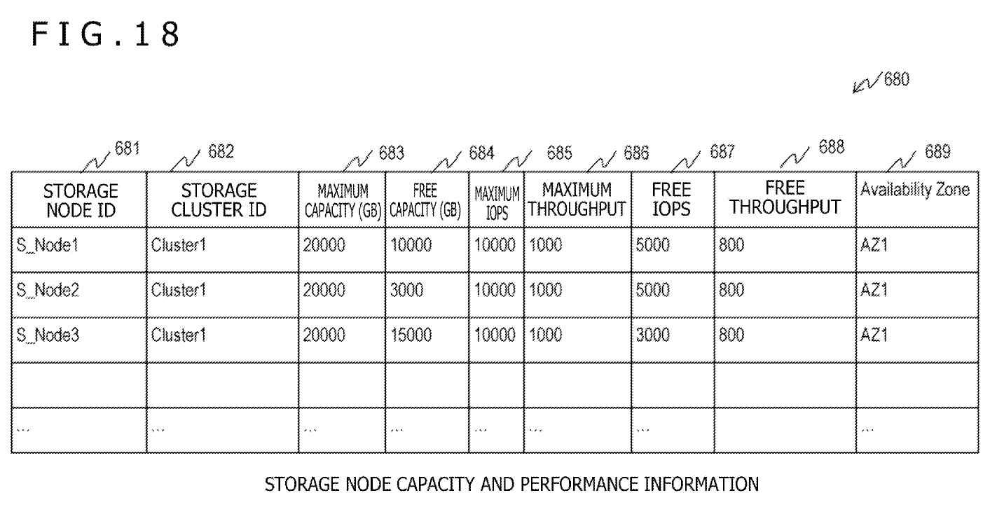

FIG. 18 illustrates a configuration example of storage node capacity and performance information 680. The storage node capacity and performance information 680 is stored in the sub-storage device 320, for example, and is referred to by the DB deployment program 12. The storage node capacity and performance information 680 manages information associated with a capacity and performance (load) of the storage node.

The storage node capacity and performance information 680 includes a storage node ID column 681, a storage cluster ID column 682, a maximum capacity column 683, a free capacity column 684, a maximum input/output operations per second (IOPS) column 685, a maximum throughput column 686, a free IOPS column 687, a free throughput column 688, and an availability zone column 689. At least part of the information may be collected from the management target system 2, and at least part of the information may be set beforehand.

The storage node ID column 681 and the storage cluster ID column 682 indicate an ID of the storage node and an ID of the cluster to which the storage node belongs, respectively. The availability zone column 689 indicates an ID of the availability zone to which the storage node belongs.

The free capacity column 684 may store a value calculated from a maximum value and an actual consumption value by use of a predetermined calculation method, such as a value obtained by subtracting an actual consumption value from a maximum capacity value. Each of the free IOPS column 687 and the free throughput column 688 may store a value calculated from a maximum value and an actual value by use of a predetermined calculation method, such as a value obtained by subtracting an average value in a predetermined period from the maximum value and a value obtained by subtracting a sum of an average value and a standard deviation for a predetermined period. Note that IOPS and throughputs may be separately managed for each of a read process and a write process.

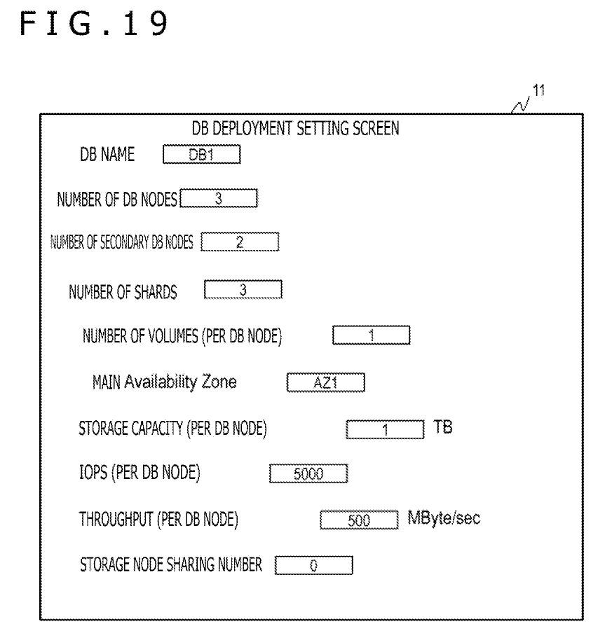

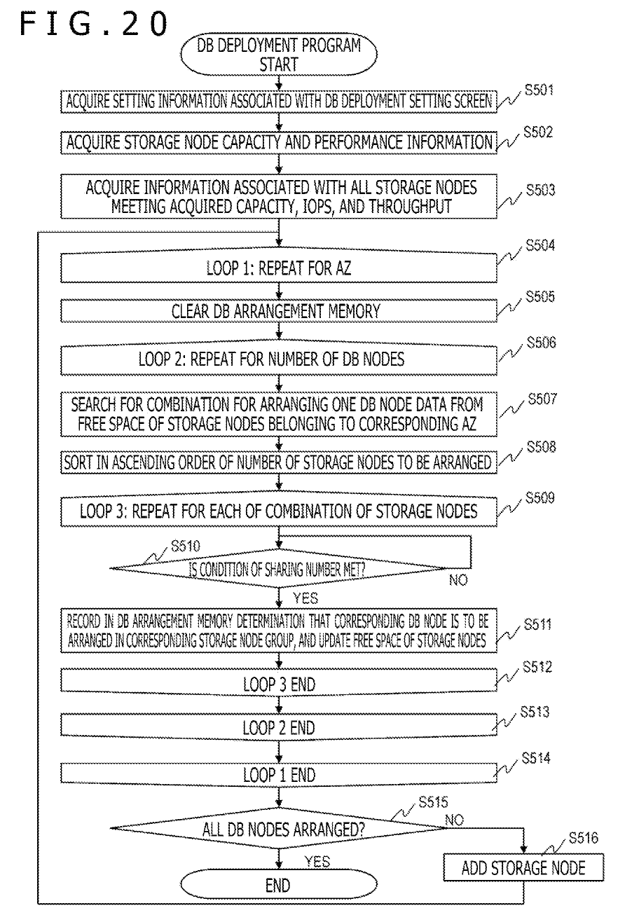

FIG. 19 illustrates an example of a DB deployment setting screen 11 displayed by the DB deployment program 12. The DB deployment setting screen 11 includes a section to which configuration information associated with a DB cluster (distributed DB system) is input from the manager (user). In the configuration example illustrated in FIG. 19, the manager inputs information associated with an operating group, for example.

The DB deployment setting screen 11 includes input sections for a DB name, the number of DB nodes, the number of secondary DB nodes, the number of shards, the number of volumes, an ID of a main (active) availability zone, a storage capacity per shard, IOPS per shard, a throughput per shard, and a storage node sharing number. The number of volumes indicates the number of volumes accessed by each DB node. The storage capacity, the IOPS, and the through put are values required for each storage node. The storage node sharing number is the number of DB nodes accessing one storage node (volumes provided by one storage node). Volumes are arranged such that the sharing number within the system becomes a setting value or smaller.

Note that database performance such as transaction per second (TPS) may be set instead of storage performance. Storage performance can be calculated (estimated) from DB performance by use of a predetermined calculation formula. Moreover, at least part of information may be set and registered in the DB management system 1 without requiring the manager to set the part of information. The sharing number may be set and counted separately for primary DB nodes (shards) and secondary DB nodes (shards) in a database. This configuration allows input of more detailed settings.

FIG. 20 is a flowchart illustrating an example of a DB node arrangement process. The present process may be executed during construction of a distributed database, or during addition of a new DB node (during setting change).

The DB deployment program 12 acquires setting information input to the DB deployment setting screen (S501). The DB deployment program 12 divides a storage capacity, IOPS, and a throughput thus acquired by the number of acquired volumes, and uses resultant numerical values for the following processing. According to the present example, the process is executed on an assumption that the IOPS, the throughput, and the capacity are equally distributed for a plurality of the volumes. However, if the IOPS, the throughput, and the capacity of each volume can be input to the DB deployment setting screen, the respective values of these items may be used. The DB deployment program 12 further acquires the storage node capacity and performance information 680 (S502). The DB deployment program 12 acquires information associated with all storage nodes meeting the storage capacity, the IOPS, and the throughput (S503).

The DB deployment program 12 executes steps S504 through S514 for each of availability zones. In step S505, the DB deployment program 12 clears a DB arrangement memory.

The DB deployment program 12 repeats steps S506 through S513 for the number of DB nodes. The DB deployment program 12 searches for combinations allowing arrangement of a volume of one DB node from a free space of the storage nodes belonging to the corresponding AZ (S507). The DB deployment program 12 further executes sorting in an ascending order of the number of storage nodes to be arranged (S508).

The DB deployment program 12 executes steps S509 through S512 for each of the combinations of the storage nodes. The DB deployment program 12 determines whether these combinations of the storage nodes meet the condition of the sharing number (S510). In other words, it is determined whether the sharing number is a setting value or smaller. The sharing number is the number of DB nodes sharing one storage node. In a case where the condition of the sharing number is not met (S510: NO), the DB deployment program 12 selects the subsequent combination of the storage nodes, and determines whether this combination meets the condition of the sharing number.

In a case where the condition of the sharing number is met (S510: NO), the DB deployment program 12 records in the DB arrangement memory a determination that the volume of the corresponding DB node is to be arranged in the corresponding storage node group, and updates the free space of the storage nodes (S511). The condition of the sharing number may be set and determined for each of the primary DB nodes and the secondary DB nodes. When both of the conditions are met, step S511 is executed.

After completion of a loop from step S504 through step S514, the DB deployment program 12 determines whether all of the DB nodes have been arranged (S515). In a case where at least some of the DB nodes have not been arranged (S515: NO), the DB deployment program 12 adds a storage node (S516). The addition number is dependent on design of each storage cluster. In a case where all of the DB nodes have been arranged (S515: YES), the present flow ends.

Note that the present invention is not limited to the examples described above, and may include various modifications. For example, the examples presented above have been discussed in detail only for the purpose of explaining the present invention in an easily comprehensible manner. Accordingly, the present invention is not necessarily required to have all of the configurations described above. Moreover, some of the configurations of one example may be replaced with the configurations of other examples, and the configurations of one example may be added to the configurations of other examples. Furthermore, addition of other configurations to some of the configurations of the respective examples and deletion and replacement of some of the configurations of the respective examples may be made.

In addition, some or all of the respective configurations, functions, processing units, and the like described above may be implemented by hardware, such as design with use of integrated circuits. Moreover, the respective configurations, the functions, and the like described above may be implemented by software with use of a processor which interprets a program performing the respective functions and executes this program. Information for achieving the respective functions, such as a program, a table, and a file may be provided in a recording device such as a memory, a hard disk, and a solid state drive (SSD), or a recording medium such as an integrated circuit (IC) card and a secure digital (SD) card.

Furthermore, control lines and information lines presented above are those considered as necessary for explanation. Accordingly, all control lines and information lines required for products are not necessarily presented. In practice, almost all of the configurations may be considered to be connected to each other.

What is claimed is:

1. A management system for managing a management target system, the management system comprising:
one or more processors; and
one or more storage devices, wherein
the management target system includes
a storage cluster that includes a plurality of storage nodes, and
a database cluster that includes a plurality of database nodes,
the plurality of storage nodes include a plurality of active storage nodes arranged in a first zone and a plurality of standby storage nodes arranged in a second zone,
the plurality of database nodes include a plurality of active database nodes arranged in the first zone and a plurality of standby database nodes arranged in the second zone,
failover is executed between the plurality of active storage nodes and the plurality of standby storage nodes,
failover is executed between the plurality of active database nodes,
the one or more storage devices store management information,
the management information includes
information associated with an active type or a standby type and a zone of each of the plurality of storage nodes and status information associated with the storage nodes, and
information associated with an active type or a standby type, a zone, and an access destination storage node of each of the plurality of database nodes and status information associated with the database nodes, and,
with reference to the management information, the one or more processors detect anomaly in the first zone, determine which of a zone failure, a failure of only the storage node, and a failure of only the database node corresponds to a cause of the anomaly, and create an instruction for operating the management target system according to a result of the determination.

2. The management system according to claim 1, wherein the one or more processors transmit the created instruction to the management target system.

3. The management system according to claim 1, wherein, in a case where the cause of the anomaly is the failure of only the storage node, the one or more processors create an instruction for executing failover of a related one of the active database nodes that accesses a corresponding one of the active storage nodes that is causing the failure.

4. The management system according to claim 3, wherein
the management information includes information associated with a primary node and one or more secondary nodes included in the plurality of active database nodes,
the one or more processors determine whether the number of the secondary nodes becomes smaller than a predetermined value as a result of failover of the related active database node, with reference to the management information, and
the one or more processors create an instruction for adding a secondary node before failover of the related active database node in a case where the number of the secondary nodes becomes smaller than the predetermined value.

5. The management system according to claim 3, wherein
the plurality of active database nodes include a primary node and one or more secondary nodes,
the database cluster manages a plurality of shards,
the one or more processors determine, for each of the shards, whether the number of the secondary nodes becomes smaller than a predetermined value as a result of failover of the related active database node, and
the one or more processors create an instruction for adding a secondary node before the failover in a case where the number of the secondary nodes becomes smaller than the predetermined value.

6. The management system according to claim 1, wherein the one or more processors arrange volumes in the storage cluster such that a sharing number of each of the storage nodes by the database nodes becomes a designated value or smaller in each of the first zone and the second zone at a time of construction of the database cluster or addition of the database node to the database cluster.

7. The management system according to claim 6, wherein
the plurality of active database nodes include a primary node and one or more secondary nodes,
the plurality of standby database nodes include a primary node and one or more secondary nodes, and
the one or more processors arrange volumes in the storage cluster such that each of a sharing number of the primary node and a sharing number of the secondary node becomes a designated value or smaller in each of the first zone and the second zone.

8. A management method of a management system for managing a management target system,
the management target system including
a storage cluster that includes a plurality of storage nodes, and
a database cluster that includes a plurality of database nodes, wherein
the plurality of storage nodes include a plurality of active storage nodes arranged in a first zone and a plurality of standby storage nodes arranged in a second zone,
the plurality of database nodes include a plurality of active database nodes arranged in the first zone and a plurality of standby database nodes arranged in the second zone,
failover is executed between the plurality of active storage nodes and the plurality of standby storage nodes,
failover is executed between the plurality of active database nodes,
the management system stores management information,
the management information includes
information associated with an active type or a standby type and a zone of each of the plurality of storage nodes and status information associated with the storage nodes, and
information associated with an active type or a standby type, a zone, and an access destination storage node of each of the plurality of database nodes and status information associated with the database nodes, and
the management method causes the management system to, with reference to the management information, detect anomaly in the first zone, determine which of a zone failure, a failure of only the storage node, and a failure of only the database node corresponds to a cause of the anomaly, and create an instruction for operating the management target system according to a result of the determination.
